(19) United States
(12) Patent Application Publication
(10) Pub. No.: US 2004/0035396 A1
(43) Pub. Date: Feb. 26, 2004

(54) High pressure fuel pump for a fuel system on a direct injection internal combustion engine, fuel system and internal combustion engine

(76) Inventors: Markus Braun, Stuttgart (DE); Silvia Gulden, Stuttgart (DE); Igor Luchs, Marbach (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/297,766

(22) PCT Filed: Apr. 5, 2002
(86) PCT No.: PCT/DE02/01248

(30) Foreign Application Priority Data
Apr. 7, 2001 (DE) 01 01 17 600.7

(51) Int. Cl. F04B 1/04; F02M 37/04

(52) U.S. Cl. 123/447; 417/273

(57) ABSTRACT

A high-pressure fuel pump (10) is used for a fuel system of a direct-injecting internal combustion engine. This pump includes a housing (14, 32). It is also provided with a low-pressure inlet (16) and a delivery chamber (20). The fuel is compressed in the delivery chamber (20). An insert (38) is also provided, which delimits the delivery chamber (20) in the direction toward the low-pressure inlet (16). The insert (38) contains at least one radial flow conduit (48). The insert (38) is axially supported against the housing (32). The high-pressure fuel pump (10) also has a high-pressure outlet (18). In order to reduce the manufacturing costs of the high-pressure fuel pump (10), the invention proposes that the radial flow conduit (48) be delimited by a recess in an axial end face (44) of the insert (38).

### PRIOR ART

The invention relates first to a high-pressure fuel pump for a fuel system of a direct-injecting internal combustion engine, with a housing, with a low-pressure inlet, with a delivery chamber in which the fuel is compressed, with an insert that delimits the delivery chamber in the direction of the low-pressure inlet, wherein the insert has at least one radial flow conduit and wherein the insert is supported axially against the housing, and with a high-pressure outlet.

A high-pressure fuel pump of this kind is known from the market. It is a 3-cylinder radial piston pump. It is used to compress the fuel to the high pressure used in direct-injecting internal combustion engines. The piston of the radial piston pump delimits a delivery chamber, which is filled with fuel via a low-pressure inlet during an intake stroke.

The fuel disposed in the delivery chamber is compressed in the delivery chamber during a compression stroke. If the pressure of the fuel in the delivery chamber has reached a certain level, then the fuel is ejected to a high-pressure outlet via a pressure control valve.

Between the low-pressure inlet and the delivery chamber, there is an insert, which is disposed coaxial to the delivery chamber and against which a piston spring is supported. A number of obliquely-extending flow conduits extend radially outward through the wall of the annular insert and the fuel flows through these flow conduits from the low-pressure inlet into the delivery chamber.

The object of the current invention is to modify a high-pressure fuel pump of the type mentioned at the beginning so that it can be produced at a lower cost and has a longer service life.

This object is attained in a high-pressure fuel pump of the type mentioned at the beginning by virtue of the fact that a recess in an axial end surface of the insert delimits the radial flow conduit.

### ADVANTAGES OF THE INVENTION

The invention is based on the knowledge that producing the radial through bores in the insert of the known high-pressure fuel pump is relatively time-consuming and requires cost-intensive machining. By contrast, the recess provided in an axial end face of the insert in the high-pressure fuel pump according to the invention is extremely easy to produce since this region can be easily accessed from the outside. This reduces the manufacturing costs of the high-pressure fuel pump according to the invention.

It has also been observed that when the known high-pressure fuel pump was used, cracks always developed in the vicinity of the radially inner mouth of the radial flow conduits. With the use of the high-pressure fuel pump according to the invention, because the radial flow conduit is simply constituted by a recess in the axial end face of the insert, the diffusion of stress in the insert is more homogeneous, which counteracts the development of cracks. This extends the service life of the high-pressure fuel pump according to the invention.

Advantageous modifications of the invention are disclosed in the dependent claims.

In a first modification, the invention discloses that a continuous axial flow conduit is provided in the insert, that the radial flow conduit is formed in the end face of the insert oriented away from the delivery chamber, and that the radial and axial flow conduits are fluidically connected to each other. This permits a filling of the delivery chamber during the intake phase that is optimal in terms of flow.

It is possible in this connection for the radial flow conduit to be produced by being milled into the axial end face of the insert. A milling of this kind is inexpensive. The machining can also optionally include a grinding operation.

The invention also proposes that the insert have at least three, in particular four, radial flow conduits arranged in a star pattern. This number of flow conduits reduces the flow resistance during the intake phase of the high-pressure fuel pump. On the other hand, this number of flow conduits does not significantly reduce the contact surface area between the insert and the housing.

In another embodiment of the high-pressure fuel pump according to the invention, at least one radial flow conduit has a rectangular cross section. It can easily be produced by being milled. In order to keep the stresses in the insert to a minimum, the corners of the radial flow conduit are preferably rounded.

Alternatively or in addition to this, it is also possible for at least one radial flow conduit to have a trough-shaped base. This is particularly advantageous with regard to the homogeneity of the stresses in the insert.

In a particularly preferable modification of the high-pressure fuel pump according to the invention, the end of the insert oriented away from the delivery chamber is supported in a recess in the housing. This reliably secures the insert in the radial direction.

In order to produce optimal flow conditions, it is advantageous in this case if the diameter of the recess in the housing, at least in some areas, is greater than the outer diameter of the insert so that between the radial wall of the recess and the radially outer wall of the insert, an annular chamber is produced that fluidically connects the radial flow conduit to the low-pressure inlet.

The recess in which the insert is supported is advantageously let into a separate housing part. This reduces manufacturing costs. This is taken into account in the modification of the high-pressure fuel pump according to the invention in which the housing contains a screw, which closes a delivery chamber bore in relation to the outside, and the recess is disposed in the end face of this screw oriented toward the delivery chamber.

The invention also relates to a fuel system with a fuel tank, with at least one injection valve that injects the fuel directly into the combustion chamber of an internal combustion engine, with at least one high-pressure fuel pump, and with a fuel accumulation line to which the injection valve is connected.

A fuel system of this kind is likewise known from the market. In such a fuel system, a low-pressure fuel pump usually first supplies the fuel from a fuel tank to the high-pressure fuel pump. This high-pressure fuel pump conveys it on into the fuel accumulation line, which is generally also referred to as the “rail”. The fuel is stored at high pressure in the fuel accumulation line.

In order to reduce the manufacturing costs for such a fuel system and in order to extend the service life of the components of the fuel system, the invention proposes that the high-pressure fuel pump be embodied in the manner described above.

The invention also relates to an internal combustion engine with at least one combustion chamber into which the fuel is directly injected.

An internal combustion engine of this kind is also known from the market. The fuel can be gasoline or diesel. The direct injection of the fuel into the combustion chamber of the engine has advantages with regard to emissions and consumption.

In order to reduce the costs of the internal combustion engine and to extend its service life, the invention proposes that it have a fuel system of the type described above.

### DRAWINGS

Exemplary embodiments of the invention will be described in detail below in conjunction with the accompanying drawings.

FIG. 1 shows a cross section through a high-pressure fuel pump;

FIG. 2 shows an enlarged view of the detail II from FIG. 1;

FIG. 3 shows a side view of a first exemplary embodiment of an insert for the high-pressure fuel pump from FIG. 1;

FIG. 4 shows a top view of the insert from FIG. 3;

FIG. 5 shows a section along the line V-V from FIG. 4;

FIG. 6 shows a view similar to FIG. 3 of a second exemplary embodiment of an insert for the high-pressure fuel pump from FIG. 1; and

FIG. 7 shows a schematic depiction of an internal combustion engine with a fuel system, which includes a high-pressure fuel pump according to FIG. 1.

### DESCRIPTION OF THE EXEMPLARY EMBODIMENTS

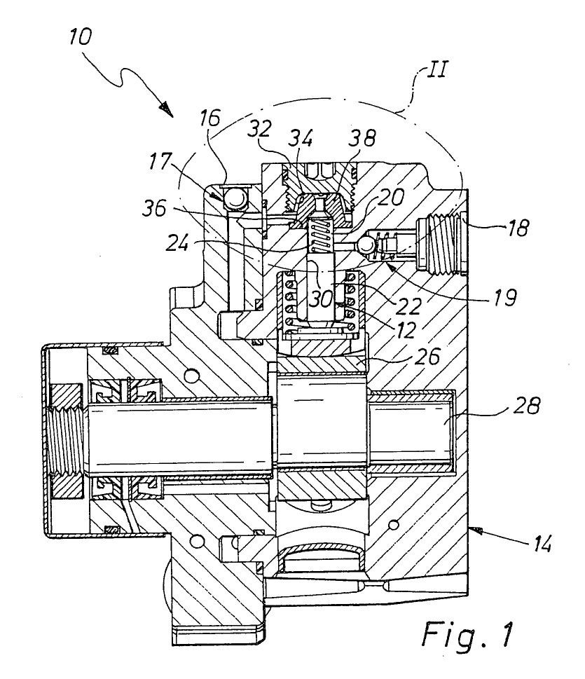

In FIG. 1, a high-pressure fuel pump is labeled as a whole with the reference numeral 10. It is a radial piston pump with a total of three cylinders, only one of which is shown in FIG. 1, labeled with the reference numeral 12. The radial piston pump 10 includes a housing 14. The housing 14 contains a low-pressure inlet 16 and a high-pressure outlet 18.

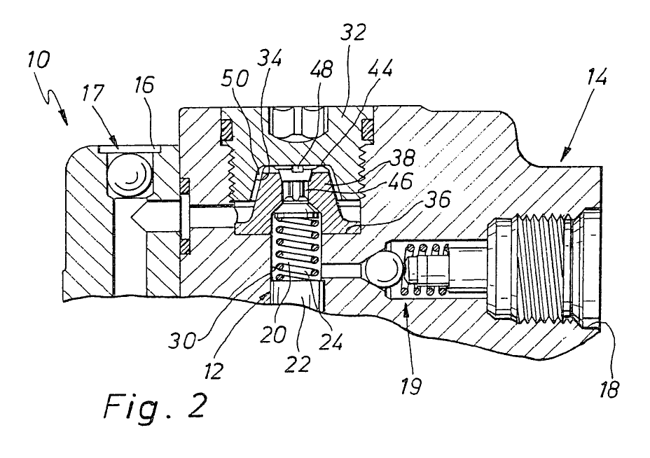

By means of pressure control valves 17 and 19 and flow conduits (not numbered), the low-pressure inlet 16 and the high-pressure outlet 18 are connected to a delivery chamber 20, which is delimited among other things, by a delivery piston 22. The delivery piston 22 is pressed against a cam 26 by a compression spring 24. The cam 26 is in turn fastened to a shaft 28, which is driven by an internal combustion engine that is not shown in FIGS. 1 and 2.

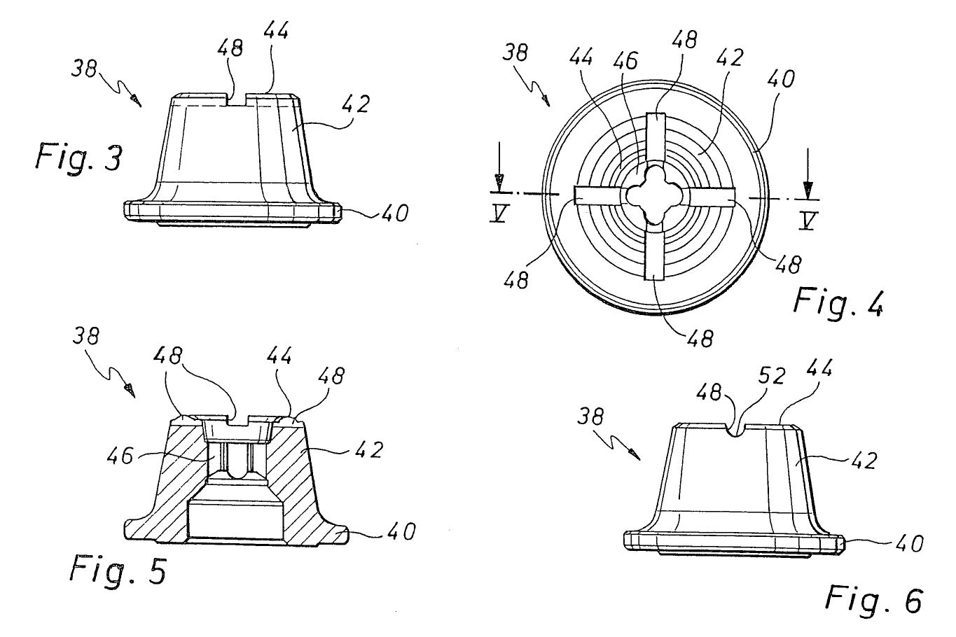

The delivery chamber 20 and also the space in which the delivery piston 22 is guided are part of a delivery chamber bore 30 in the housing 14. A screw 32 closes the delivery chamber bore 30 toward the outside. A recess 34 is let into the end face of the screw 32 oriented toward the delivery chamber 20. An insert 38 is clamped between the bottom of the recess 34 and a shoulder 36 of the delivery chamber bore 30. The precise embodiment of this insert 38 will now be explained with reference to FIGS. 3 to 5 (not all of the reference numerals are shown in FIGS. 1 and 2 for the sake of clarity):

The insert 38 has a bell-shaped external form that has a collar section 40 with a larger diameter and a main section 42, which tapers toward the top in FIGS. 1 to 3 and 5. The diameter of the collar section 40 corresponds approximately to the diameter of the shoulder 36 of the delivery chamber bore 30 so that the insert 38 is reliably centered in relation to the delivery chamber bore 30. The insert 38 is a rotationally symmetrically shaped part whose longitudinal axis coincides with the longitudinal axis of the delivery chamber bore 30.

Oriented away from the delivery chamber 20, the insert 38 has an end face 44 against which the bottom of the recess 34 in the screw 32 is pressed when the screw 32 is tightened. The insert 38 has an axial flow conduit 46 passing through it. Four radial grooves 48 distributed over the circumference are milled into the end face 44. The radial grooves 48 constitute flow conduits, which are fluidically connected to the axial flow conduit 46.

In the exemplary embodiment of an insert 38 shown in FIGS. 3 to 5, the flow conduits 48 have a rectangular cross section; the corners of the radial flow conduits 48 are rounded. The diameter of the recess 34 in the screw 32 is greater than the outer diameter of the main section 42 of the insert 38. An annular chamber 50 is formed between the radial wall of the recess 34 and the radial outer wall of the insert 38. This annular chamber 50 connects the radial flow conduits 48 to the low-pressure inlet 16.

The radial piston pump 10 shown in FIGS. 1 and 2 operates as follows: when the shaft 28 rotates, the delivery piston 22 is first moved axially toward the shaft 28, i.e. downward in FIGS. 1 and 2, due to the action of the compression spring 24. As a result, fuel travels into the delivery chamber 20 by means of the low-pressure inlet 16, the inlet valve 17, the inlet conduit, the annular chamber 50, the radial flow conduits 48 in the insert 38, and the axial flow conduit 46 in the insert 38. The outlet valve is closed during this intake stroke.

Then in the course of the rotation of the shaft 28, the delivery piston 22 is moved toward the insert 38. As a result, the inlet valve 17 closes and the fuel in the delivery chamber 20 is compressed. If the pressure in the delivery chamber 20, for example, exceeds the pressure in the vicinity of the high-pressure outlet 18, then the outlet valve 19 opens and the compressed fuel in the delivery chamber 20 can flow out in the direction of the high-pressure outlet.

FIG. 6 shows a second exemplary embodiment of an insert 38, which can be used in the high-pressure fuel pump 10. Those parts and sections that are functionally equivalent to parts and sections of the insert 38 described in FIGS. 3 to 5 have been provided with the same reference numerals and will not be discussed in further detail.

The difference between the insert 38 shown in FIG. 6 and the one shown in FIGS. 3 to 5 involves the embodiment of the radial flow conduits 48: whereas in the insert 38 shown in FIGS. 3 to 5, these flow conduits had a rectangular cross section with rounded corners, in the insert 38 shown in FIG. 6, they have a round, trough-shaped base 52.

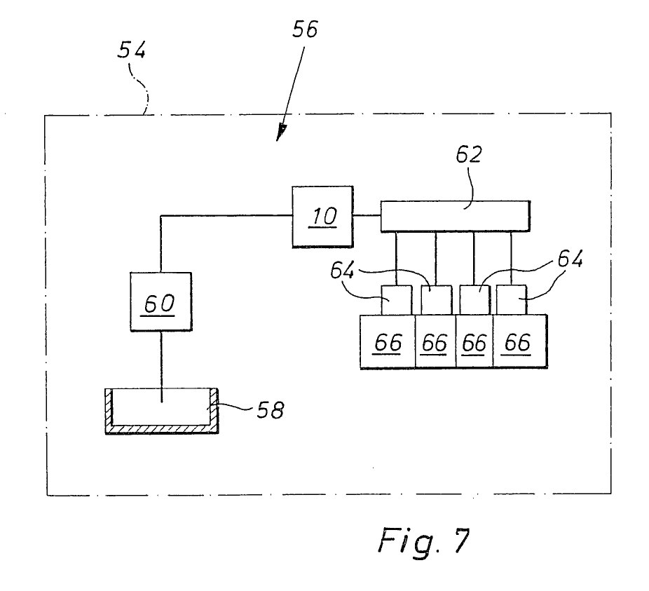

FIG. 7 is a schematic depiction of an internal combustion engine 54. It includes a fuel system 56. This fuel system in turn has a fuel tank 58 from which an electric low-pressure fuel pump 60 delivers fuel.

The electric low-pressure fuel pump 60 feeds to a high-pressure fuel pump 10, which is embodied as shown in FIGS. 1 and 2. The high-pressure outlet 18 of the high-pressure fuel pump 10 is connected to a fuel accumulation line 62. This is generally also referred to as the “rail”. The fuel accumulation line 62 has a total of four injection valves 64 connected to it. These inject the fuel directly into combustion chambers 66.

1. A high-pressure fuel pump (10) for a fuel system (56) of a direct-injecting internal combustion engine (54), with a housing (14, 32), with a low-pressure inlet (16), with a delivery chamber (20) in which the fuel is compressed, with an insert (38) that delimits the delivery chamber (20) in the direction toward the low-pressure inlet (16), wherein the insert (38) has at least one radial flow conduit (48) and wherein the insert (38) is axially supported against the housing (32), and with a high-pressure outlet (18), characterized in that the radial flow conduit (48) is delimited by a recess in an axial end face (44) of the insert (38).

2. The high-pressure fuel pump (10) according to claim 1, characterized in that a continuous axial flow conduit (46) is provided in the insert (38), that the radial flow conduit (48) is embodied in the end face (44) of the insert (38) oriented away from the delivery chamber (20), and that the radial flow conduit (48) and the axial flow conduit (46) are fluidically connected to each other.

3. The high-pressure fuel pump (10) according to one of claims 1 or 2, characterized in that the radial flow conduit (48) is produced by being milled into the axial end face (44) of the insert (38).

4. The high-pressure fuel pump (10) according to one of the preceding claims, characterized in that the insert (38) contains a total of at least three, in particular four, radial flow conduits (48) arranged in a star pattern.

5. The high-pressure fuel pump (10) according to one of the preceding claims, characterized in that at least one radial flow conduit (48) has a rectangular cross section.

6. The high-pressure fuel pump (10) according to claim 5, characterized in that the corners of the radial flow conduit (48) are rounded.

7. The high-pressure fuel pump (10) according to one of the preceding claims, characterized in that at least one radial flow conduit (48) has a trough-shaped base (52).

8. The high-pressure fuel pump (10) according to one of the preceding claims, characterized in that the end of the insert (38) oriented away from the delivery chamber (20) is supported in a recess (34) in the housing (32).

9. The high-pressure fuel pump (10) according to claim 8, characterized in that the diameter of the recess (34) in the housing (32), at least in some areas, is greater than the outer diameter of the insert (38) so that between the radial wall of the recess (34) and the radial outer wall of the insert (38), an annular chamber (50) is produced, which fluidically connects the radial flow conduit (48) to the low-pressure inlet (16).

10. The high-pressure fuel pump (10) according to one of claims 8 or 9, characterized in that the housing contains a screw (32), which closes a delivery chamber bore (30) in relation to the outside and the recess (34) is provided in the end face of this screw (32) oriented toward the delivery chamber (20).

11. A fuel system (56) with a fuel tank (58), with at least one injection valve (64) that injects the fuel directly into the combustion chamber (66) of an internal combustion engine (54), with at least one high-pressure fuel pump (10), and with a fuel accumulation line (62) to which the injection valve (64) is connected, characterized in that the high-pressure fuel pump (10) is embodied according to one of claims 1 to 10.

12. An internal combustion engine (54) with at least one combustion chamber (66), into which the fuel is directly injected, characterized in that the engine has a fuel system (56) according to claim 11.
